(19) United States
(12) Patent Application Publication
(10) Pub. No.: US 2023/0190042 A1
(43) Pub. Date: Jun. 22, 2023

(54) Disc Grinding Device and Grinder Comprising the Same

(71) Applicant: FrymaKoruma AG, Rheinfelden (CH)

(72) Inventor: Hans Brogli, Rheinfelden (CH)

(21) Appl. No.: 18/083,534

(22) Filed: Dec. 18, 2022

(30) Foreign Application Priority Data
Dec. 20, 2021 (DE) 202021003832.9

(51) Int. Cl. A47J 42/20; A47J 42/18

(52) U.S. Cl. CPC A47J 42/20; A47J 42/18

(57) ABSTRACT

The invention relates to a disc grinding device (2) with a stator disc (3) and a rotor disc (4) which are disposed coaxially with respect to a common disc axis and have at least approximately the same diameter, and the mutually facing sides of which correspondingly contain an annular toothed stator surface and an annular toothed rotor surface, wherein the annular toothed stator surface contains at least one stator ring region with stator teeth, which are spaced apart by stator grooves in the peripheral direction, and the annular toothed rotor surface contains at least one rotor ring region with rotor teeth, which are spaced apart by rotor grooves in the peripheral direction, wherein the toothed rotor surfaces and the toothed stator surfaces define an annular grinding gap and are disposed and formed in such a way that the grinding gap becomes narrower radially in the direction from the disc axis towards the edge of the stator disc (3) and rotor disc (4), wherein the rotor teeth and rotor grooves extend in an inclined or curved manner with respect to the radial direction of the rotor disc (4), and/or wherein at least two stator ring regions with stator teeth and/or rotor ring regions with rotor teeth lie adjacently in the radial direction of the stator disc (3) or rotor disc (4) respectively and have stator teeth or rotor teeth respectively and/or stator grooves or rotor grooves respectively of different designs, and/or wherein the stator grooves and/or rotor grooves become narrower in the direction from the disc axis towards the edge of the stator disc (3) or rotor disc (4) respectively. The invention furthermore relates to a grinder (1) comprising such a disc grinding device (2).

The invention relates to a disc grinding device and a grinder comprising the same. Furthermore, this gives rise to a grinding method using such a disc grinding device and grinder.

A generic disc grinding device is based on a rotor/stator principle and contains a stator disc and a rotor disc which are disposed coaxially with respect to a common disc axis and are of at least approximately the same diameter, and the mutually facing sides thereof correspondingly contain an annular toothed stator surface and an annular toothed rotor surface, i.e. each comprise a tooth arrangement. The annular toothed stator surface contains at least one stator ring region with stator teeth which are spaced apart by stator grooves in the peripheral direction. Similarly, the annular toothed rotor surface comprises at least one rotor ring region with rotor teeth which are spaced apart in the peripheral direction by rotor grooves.

Upon rotation of the rotor, the rotor teeth temporarily lie at least partially opposite the stator teeth and, with their toothed rotor surfaces and toothed stator surfaces, define an annular grinding gap. The toothed stator surfaces and the toothed rotor surfaces are thus disposed and formed in such a way that the grinding gap becomes narrower radially in the direction from the disc axis towards the edge of the stator disc and rotor disc. From practice e.g. in the field of disc grinding mechanisms of coffee grinders it is known that the rotor teeth and rotor grooves extend in an inclined or curved manner with respect to the radial direction of the rotor disc.

The aim of the invention is to improve the function and reliability of such a disc grinding device.

This aim is achieved with a disc grinding device and a grinder comprising the same according to the independent claims. Advantageous and/or preferred further embodiments are given in the dependent claims. The scope of the invention also includes a grinding method using such a disc grinding device and a grinder, exploiting the specific features of the grinder and disc grinding device in accordance with the invention.

The invention thus provides a disc grinding device, wherein in particular in addition to the above-mentioned generic features at least one of the following design arrangements is provided:
that the rotor teeth and rotor grooves extend in an inclined or curved manner with respect to the radial direction of the rotor disc and in combination therewith the stator teeth and stator grooves extend pointing in the radial direction of the stator disc,

and/or
that at least two stator ring regions with stator teeth and/or rotor ring regions with rotor teeth lie adjacently in the radial direction of the stator disc or rotor disc respectively and have stator teeth or rotor teeth respectively and/or stator grooves or rotor grooves respectively of different designs, wherein
   such adjacent stator ring regions and/or rotor ring regions are preferably separated by a mixing zone peripheral groove, and/or
   preferably in such adjacent stator ring regions and/or rotor ring regions in a stator ring region or rotor ring region respectively lying radially further outwards in the direction from the disc axis towards the edge of the stator disc and rotor disc, the stator grooves or rotor grooves respectively are narrower than in the stator ring region and/or rotor ring region lying adjacently further inwards radially thereto, i.e. in other words that the tooth arrangements of adjacent stator ring regions and/or rotor ring regions become narrower radially from the disc axis towards the edge of the stator disc and rotor disc, or in other words that the grinding goes from coarser to finer from the disc axis towards the edge of the stator disc and rotor disc,

and/or
that the stator grooves and/or rotor grooves become narrower in the direction from the disc axis towards the edge of the stator disc or rotor disc respectively, i.e. in other words that the tooth arrangements become narrower radially from the disc axis towards the edge of the stator disc and rotor disc, or in other words, that the grinding goes from coarser to finer from the disc axis towards the edge of the stator disc and rotor disc.

A grinder in accordance with the invention contains such a disc grinding device.

The disc grinding device operates on a rotor/stator principle. A stator disc and rotor disc, or, in short, a rotor and stator, are toothed on their mutually facing surfaces, which can also be designated as planar surfaces, i.e. in a corresponding manner on the toothed stator surface and on the toothed rotor surface.

The rotor is fastened in particular via a rotor holding flange on a grinding shaft extending coaxially with respect to the disc axis and rotates for example and preferably in a clockwise direction at a speed of e.g. approximately 1000 to approximately 4000 rpm, preferably at least approximately 3000 rpm as standard or in particular as an adjustable or controllable speed. In order to control the rotational speed of the rotor, in particular a frequency converter can be provided.

The stator is preferably screwed to a grinder upper part and is advantageously displaceable axially along the disc axis, whereby preferably the size of a grinding gap in the axial direction between the stator disc and rotor disc or the mutually facing toothed stator surface and toothed rotor surface thereof is also adjustable or controllable.

The toothed stator surface and toothed rotor surface of the stator and rotor respectively are each provided with a specific tooth arrangement. The grinding gap between the rotor and stator can also be designated as a planar gap and is preferably and advantageously of approximately 0.3 to approximately 3 mm in particular at the narrowest point and is in particular adjustable or controllable. By reason of adjustability, the grinder and its disc grinding device can be adapted both to specific products to be ground and also to a desired final level of fineness. The material to be ground is fed to the tooth arrangement from the centre via the stator. The centrifugal effect during operation, i.e. the rotation of the stator disc, also causes the product to be delivered through the tooth arrangement in addition to the grinding and it leaves the grinding zone defined by the grinding gap at the outer diameter of the stator disc and rotor disc.

The toothed stator surfaces and the toothed rotor surfaces are preferably disposed and/or formed in such a way that the grinding gap becomes narrower radially in the direction from the disc axis towards the edge of the stator disc and rotor disc. In this way or alternatively, provision can be made for the toothed stator surface and the toothed rotor surface to be disposed and/or formed in such a way that the grinding gap becomes wider in an edge region of the stator disc and rotor disc in order the final output of the completely ground product is delivered and a blockage at that point is avoided, wherein for the output by reason of the in the edge region of the stator disc and rotor disc but also the greatest absolute speed of the rotor disc prevailing at that location is required.

Furthermore, it may be preferable for at least the rotor teeth and/or rotor grooves to extend in an inclined or curved manner with respect to the radial direction of the rotor disc, such as inclined, extending or facing in particular in an anti-clockwise direction e.g. during rotation of the rotor disc in a clockwise direction. The stator teeth and/or stator grooves can also extend in an inclined or curved manner with respect to the radial direction of the rotor disc but can also extend at least substantially radially. The tooth arrangement can therefore extend from the inside outwards in both a straight and also an inclined manner with respect to the disc axis. The delivery effect can be enhanced or inhibited thereby. Provision can also be made in particular that the inclined position or curvature of the rotor teeth and/or rotor grooves and alternatively or additionally the stator teeth and/or stator grooves is formed extending in an opposing inclined or curved manner in individual rotor or stator ring regions respectively.

Over the whole grinding zone, the tooth arrangement is divided into different toothed circles, i.e. stator ring regions and/or rotor ring regions. A coarse tooth arrangement in the region adjoining the inner diameter, i.e. on the innermost stator ring region and/or rotor ring region, can be designated as a pre-grinding zone. The tooth arrangement advantageously and preferably becomes finer from the inside to the outside with each toothed circle, i.e. each stator ring region and/or rotor ring region.

The groove depth of the stator grooves and/or rotor grooves between the teeth, i.e. corresponding to the stator teeth or rotor teeth respectively preferably and advantageously extends in a conical manner. Towards the outer diameter of the stator disc and rotor disc, the stator grooves and/or rotor grooves preferably and advantageously become narrower, whereby the product parts are continuously ground finer on their path through the grinding gap radially outwards from the stator disc and rotor disc, which is effected automatically by the rotation of the rotor disc.

It is particularly preferred if the groove width is at least approximately 1.5 to 3.5 times, in particular at least approximately 2.5 times, larger than the groove depth from the toothed stator surface and/or toothed rotor surface, whereby, in an advantageous manner, jamming of the product particles in the tooth grooves, i.e. stator grooves and/or rotor grooves between the stator teeth or rotor teeth respectively can be minimised, prevented or excluded.

Each toothed circle, i.e. stator ring region and/or rotor ring region is preferably and advantageously subdivided with a ring groove which constitutes a mixing zone peripheral groove and can also be designated as a mixing zone. In this mixing zone, the product particles are mixed before they are delivered into the next finer toothed circle, i.e. stator ring region and/or rotor ring region.

Material to be ground is fed to the grinder e.g. via an open hopper or by means of a pump. The product can be discharged freely via an open outlet and in a closed conduit with some level of counter-pressure.

A grinder and a disc grinding device in accordance with the invention can be used e.g. in wet grinding technology. Typical and preferred applications are e.g. the grinding of various beans, grains and nut types with the addition of a liquid. Oleaginous beans, grains and nuts can be roasted and be ground even without the addition of liquid. However, by means of the disc grinding device in accordance with the invention, various other products can also be finely ground.

The present documents further disclose a grinding method which is based on the grinder and disc grinding device in accordance with the invention and is correspondingly advantageous, and the use of such a grinder and disc grinding device in accordance with the invention for specific product types, products and results.

The invention will be explained in more detail hereinunder merely by way of example with the aid of exemplified embodiments and with reference to the drawing in which

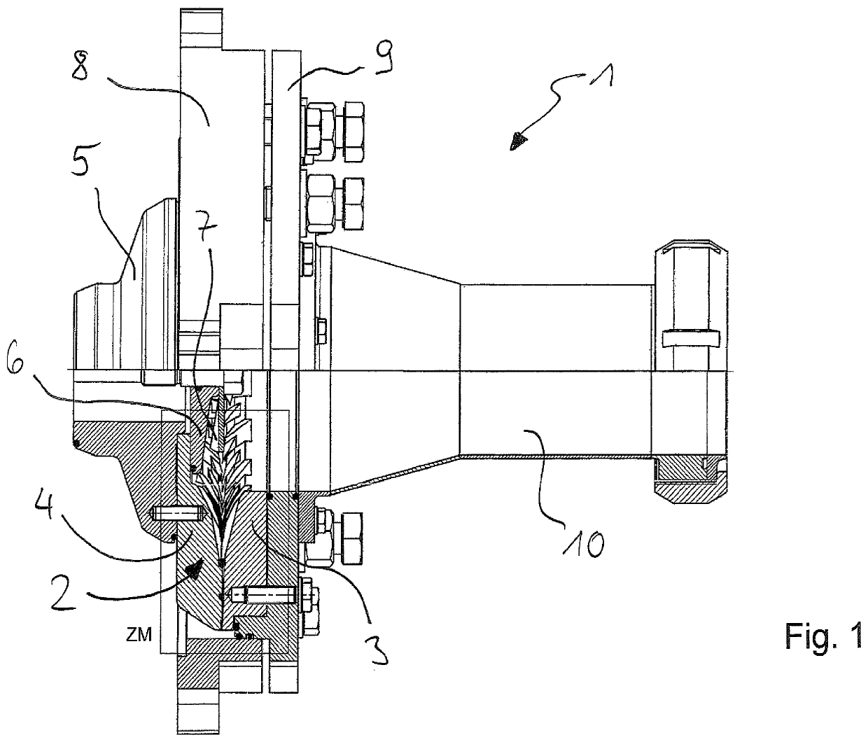

FIG. 1 shows a schematic, partially cut-away side view of an exemplified embodiment of a grinder with a disc grinding device,

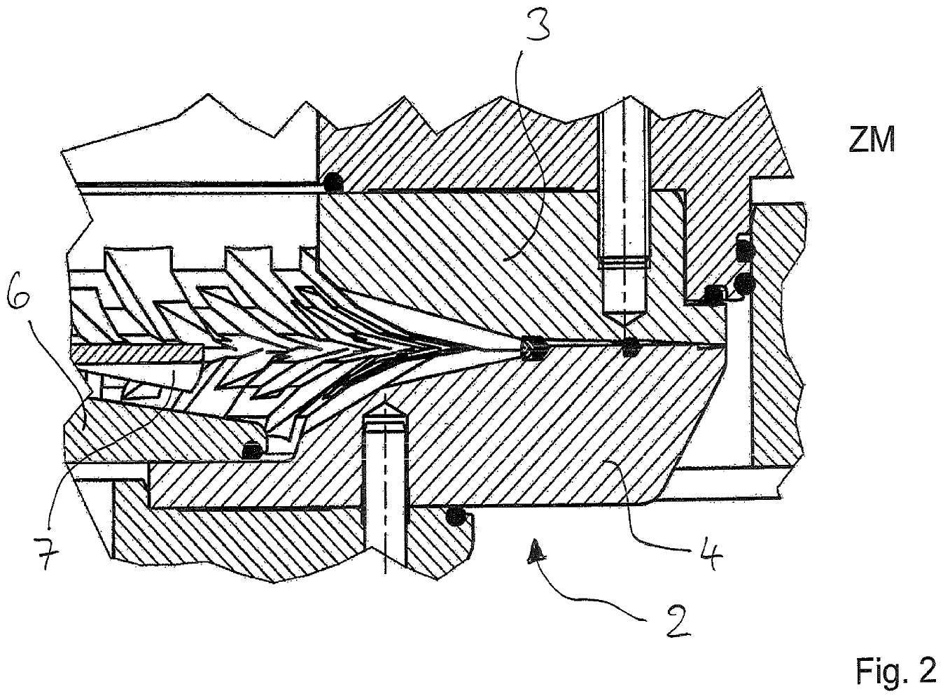

FIG. 2 shows an enlarged view of the cut-away section “ZM” of the exemplified embodiment of the grinder with the disc grinding device from FIG. 1,

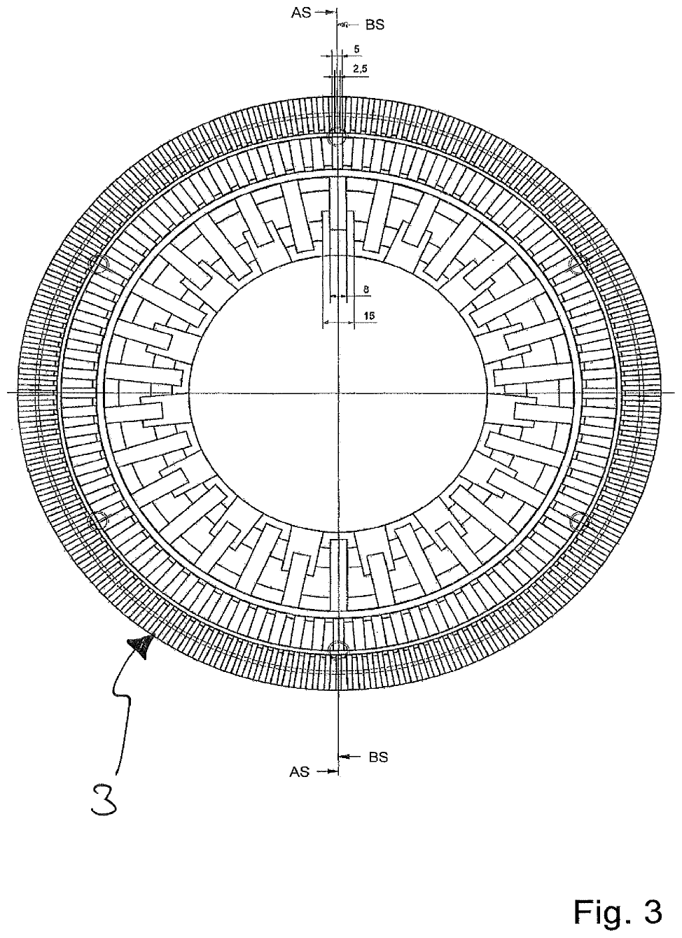

FIG. 3 shows a schematic plan view of a stator disc of the exemplified embodiment of the disc grinding device from FIG. 1,

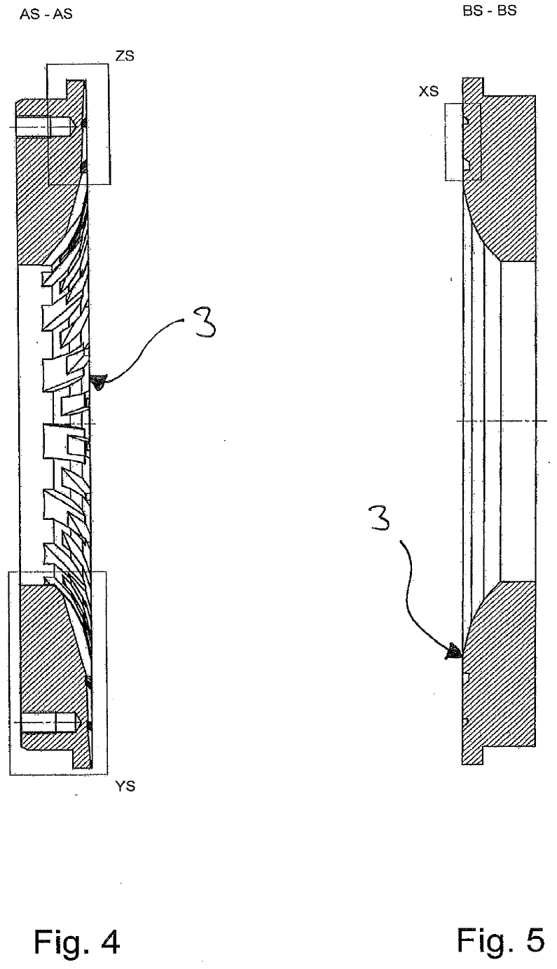

FIG. 4 shows the cross-section AS-AS of the stator disc from FIG. 3,

FIG. 5 shows the cross-section BS-BS of the stator disc from FIG. 3,

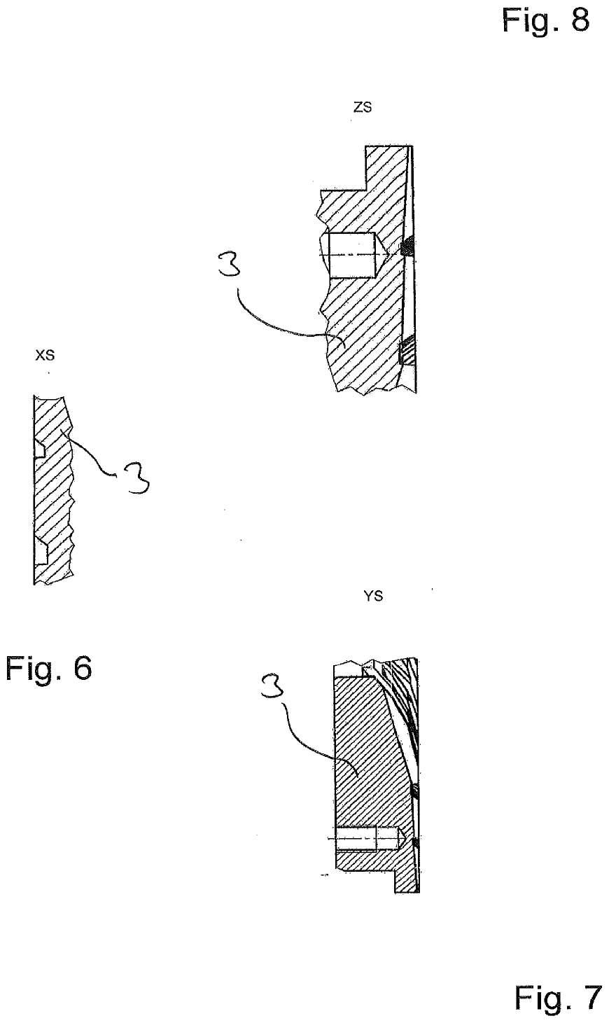

FIG. 6 shows an enlarged view of the section “XS” of the stator disc from FIG. 3,

FIG. 7 shows an enlarged view of the section “YS” of the stator disc from FIG. 3,

FIG. 8 shows an enlarged view of the section “ZS” of the stator disc from FIG. 3,

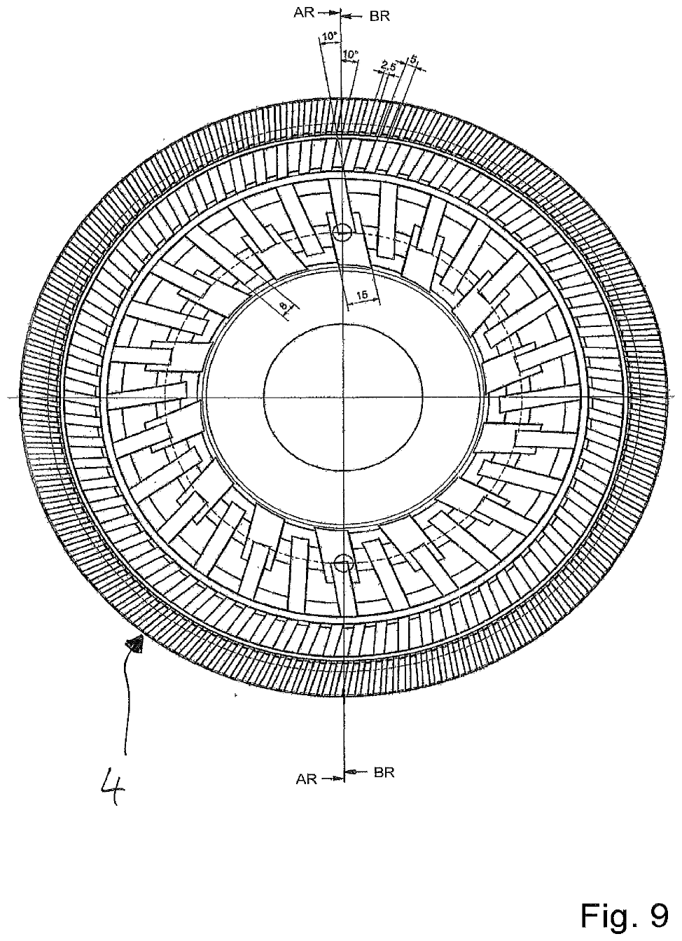

FIG. 9 shows a schematic plan view of a rotor disc of the exemplified embodiment of the disc grinding device from FIG. 1,

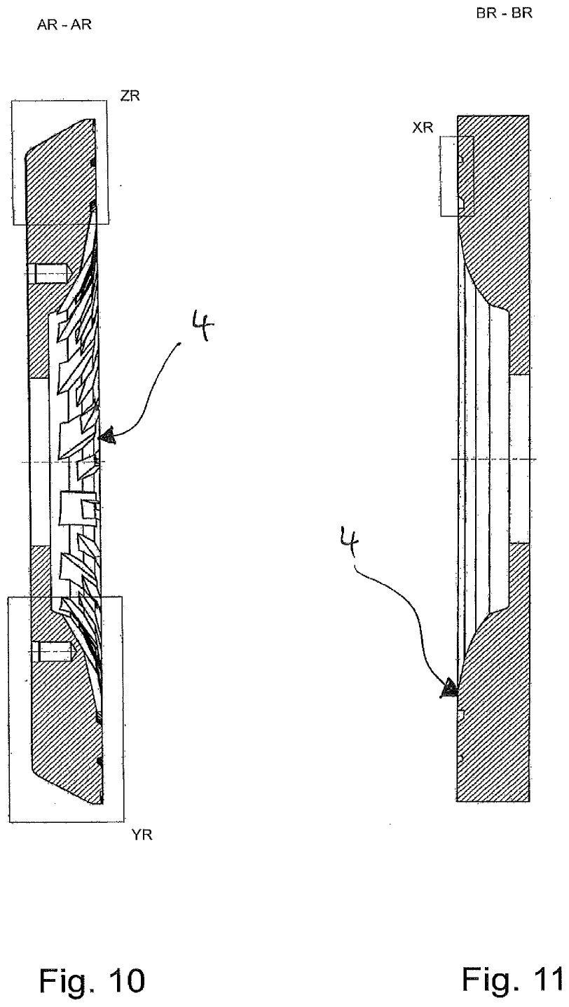

FIG. 10 shows the cross-section AR-AR of the rotor disc from FIG. 9,

FIG. 11 shows the cross-section BR-BR of the rotor disc from FIG. 9,

FIG. 12 shows an enlarged view of the section “XR” of the rotor disc from FIG. 9,

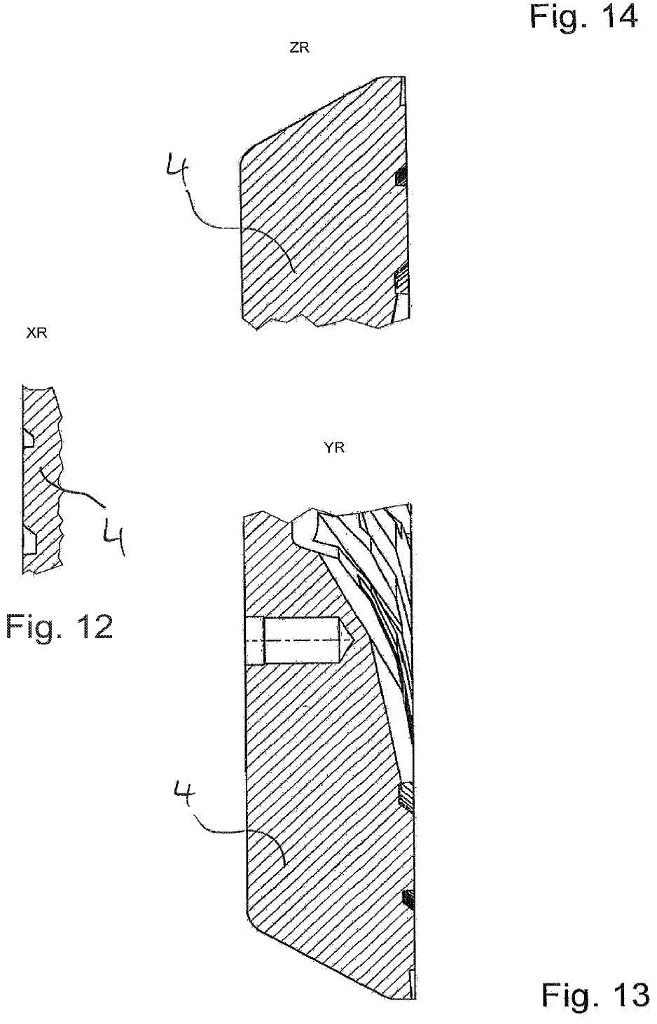

FIG. 13 shows an enlarged view of the section “YR” of the rotor disc from FIG. 9, and

FIG. 14 shows an enlarged view of the section “ZR” of the rotor disc from FIG. 9.

With the aid of the exemplified embodiments and examples of use described hereinunder and illustrated in the individual Figures of the drawing, the invention will be explained in more detail merely by way of example, i.e. it is not limited to these exemplified embodiments and examples of use or to the feature combinations within an exemplified embodiment and example of use. Method and device features will likewise also become clear from descriptions of the device and of the method respectively.

Individual features which are described and/or are illustrated in conjunction with a specific exemplified embodiment are not limited to this exemplified embodiment or the combination with the remaining features of this exemplified embodiment but, within the scope of technical possibility, can be combined with any other variants even if they have not been discussed separately in the present documents.

The same reference numerals in the individual Figures of the drawing relate to the same or similar components or components acting in the same or a similar manner. With the aid of the illustrations in the drawing, features which are not provided with reference signs will become clear, regardless of whether or not such features are described hereinunder. On the other hand, features which are contained in the present description but are not visible or illustrated in the drawing are also readily understandable to a person skilled in the art.

FIG. 1 shows a schematic and partially cut-away side view of an exemplified embodiment of a grinder 1 with a disc grinding device 2. In this FIG. 1 and in the remaining FIGS. 2 to 14, the following reference signs designate corresponding parts, components or features: grinder 1, disc grinding device 2, stator disc 3, rotor disc 4, stone plate 5, spring washer 6, feed vane 7, cam ring 8, cover 9, product in-feed/inlet 10.

In order to avoid mere repetitions, with respect to the designs and arrangements and functions, reference is made to the statements and explanations in the introductory part above which by reference also forms, in its entirety, part of the description of the Figures and exemplified embodiments.

The disc grinding device 2, as can be seen in the drawings, provides in particular in addition to the above-mentioned generic features:
that the rotor teeth and rotor grooves extend in an inclined or curved manner with respect to the radial direction of the rotor disc 4 and in combination therewith the stator teeth and stator grooves extend pointing in the radial direction of the stator disc 3.

Alternatively or in addition the disc grinding device 2 provides in particular in addition to the above-mentioned generic features:
that at least two stator ring regions with stator teeth and/or rotor ring regions with rotor teeth lie adjacently in the radial direction of the stator disc 3 or rotor disc 4 respectively and have stator teeth or rotor teeth respectively and/or stator grooves or rotor grooves respectively of different designs.

With such an embodiment such adjacent stator ring regions and/or rotor ring regions are preferably separated by a mixing zone peripheral groove. Alternatively or in addition in such adjacent stator ring regions and/or rotor ring regions in a stator ring region or rotor ring region respectively lying radially further outwards in the direction from the disc axis towards the edge of the stator disc 3 and rotor disc 4, the stator grooves or rotor grooves respectively are narrower than in the stator ring region and/or rotor ring region lying adjacently further inwards radially thereto, i.e. in other words that the tooth arrangements of adjacent stator ring regions and/or rotor ring regions become narrower radially from the disc axis towards the edge of the stator disc3 and rotor disc 4, or in other words that the grinding goes from coarser to finer from the disc axis towards the edge of the stator disc3 and rotor disc 4.

Further alternatively or in addition the disc grinding device 2 provides in particular in addition to the above-mentioned generic features:
that the stator grooves and/or rotor grooves become narrower in the direction from the disc axis towards the edge of the stator disc 3 or rotor disc 4 respectively, i.e. in other words that the tooth arrangements become narrower radially from the disc axis towards the edge of the stator disc 3 and rotor disc 4, or in other words, that the grinding goes from coarser to finer from the disc axis towards the edge of the stator disc 3 and rotor disc 4.

A grinder 1 in accordance with the invention contains such a disc grinding device 2.

The disc grinding device 2 according to the drawings operates on a rotor/stator principle. A stator disc 3 and rotor disc 4, or, in short, a rotor and stator, are toothed on their mutually facing surfaces, which can also be designated as planar surfaces, i.e. in a corresponding manner on the toothed stator surface and on the toothed rotor surface.

The rotor 4 is fastened in particular via a rotor holding flange on a grinding shaft extending coaxially with respect to the disc axis and rotates for example and preferably in a clockwise direction at a speed of e.g. approximately 1000 to approximately 4000 rpm, preferably at least approximately 3000 rpm as standard or in particular as an adjustable or controllable speed. In order to control the rotational speed of the rotor, in particular a frequency converter can be provided.

The stator 3 is preferably screwed to a grinder upper part and is advantageously displaceable axially along the disc axis, whereby preferably the size of a grinding gap in the axial direction between the stator disc and rotor disc or the mutually facing toothed stator surface and toothed rotor surface thereof is also adjustable or controllable.

The toothed stator surface and toothed rotor surface of the stator 3 and rotor 4 respectively are each provided with a specific tooth arrangement. The grinding gap between the rotor 4 and stator 3 can also be designated as a planar gap and is preferably and advantageously of approximately 0.3 to approximately 3 mm in particular at the narrowest point and is in particular adjustable or controllable. By reason of adjustability, the grinder 1 and its disc grinding device 2 can be adapted both to specific products to be ground and also to a desired final level of fineness. The material to be ground is fed to the tooth arrangement from the centre via the stator. The centrifugal effect during operation, i.e. the rotation of the stator disc 4, also causes the product to be delivered through the tooth arrangement in addition to the grinding and it leaves the grinding zone defined by the grinding gap at the outer diameter of the stator disc 3 and rotor disc 4.

The toothed stator surfaces and the toothed rotor surfaces are preferably disposed and/or formed in such a way that the grinding gap becomes narrower radially in the direction from the disc axis towards the edge of the stator disc 3 and rotor disc 4. In this way or alternatively, provision can be made for the toothed stator surface and the toothed rotor surface to be disposed and/or formed in such a way that the grinding gap becomes wider in an edge region of the stator disc 3 and rotor disc 4 in order the final output of the completely ground product is delivered and a blockage at that point is avoided, wherein for the output by reason of the in the edge region of the stator disc 3 and rotor disc 4 but also the greatest absolute speed of the rotor disc prevailing at that location is required.

Furthermore, it may be preferable for at least the rotor teeth and/or rotor grooves to extend in an inclined or curved manner with respect to the radial direction of the rotor disc 4, such as inclined, extending or facing in particular in an anti-clockwise direction e.g. during rotation of the rotor disc 4 in a clockwise direction. The stator teeth and/or stator grooves can also extend in an inclined or curved manner with respect to the radial direction of the rotor disc 4 but can also extend at least substantially radially. The tooth arrangement can therefore extend from the inside outwards in both a straight and also an inclined manner with respect to the disc axis. The delivery effect can be enhanced or inhibited thereby. Provision can also be made in particular that the inclined position or curvature of the rotor teeth and/or rotor grooves and alternatively or additionally the stator teeth and/or stator grooves is formed extending in an opposing inclined or curved manner in individual rotor or stator ring regions respectively.

Over the whole grinding zone, the tooth arrangement is divided into different toothed circles, i.e. stator ring regions and/or rotor ring regions. A coarse tooth arrangement in the region adjoining the inner diameter, i.e. on the innermost stator ring region and/or rotor ring region, can be designated as a pre-grinding zone. The tooth arrangement advantageously and preferably becomes finer from the inside to the outside with each toothed circle, i.e. each stator ring region and/or rotor ring region.

The groove depth of the stator grooves and/or rotor grooves between the teeth, i.e. corresponding to the stator teeth or rotor teeth respectively preferably and advantageously extends in a conical manner. Towards the outer diameter of the stator disc 3 and rotor disc 4, the stator grooves and/or rotor grooves preferably and advantageously become narrower, whereby the product parts are continuously ground finer on their path through the grinding gap radially outwards from the stator disc 3 and rotor disc 4, which is effected automatically by the rotation of the rotor disc 4.

It is particularly preferred if the groove width is at least approximately 1.5 to 3.5 times, in particular at least approximately 2.5 times, larger than the groove depth from the toothed stator surface and/or toothed rotor surface, whereby, in an advantageous manner, jamming of the product particles in the tooth grooves, i.e. stator grooves and/or rotor grooves between the stator teeth or rotor teeth respectively can be minimised, prevented or excluded.

Each toothed circle, i.e. stator ring region and/or rotor ring region is preferably and advantageously subdivided with a ring groove which constitutes a mixing zone peripheral groove and can also be designated as a mixing zone. In this mixing zone, the product particles are mixed before they are delivered into the next finer toothed circle, i.e. stator ring region and/or rotor ring region.

Material to be ground is fed to the grinder 1 e.g. via an open hopper or by means of a pump to the product inlet 10. The product can be discharged freely via an open outlet and in a closed conduit with some level of counter-pressure.

A grinder 1 and a disc grinding device 2 in accordance with the invention can be used e.g. in wet grinding technology. Typical and preferred applications are e.g. the grinding of various beans, grains and nut types with the addition of a liquid. Oleaginous beans, grains and nuts can be roasted and be ground even without the addition of liquid. However, by means of the disc grinding device 2 in accordance with the invention, various other products can also be finely ground.

The present documents further disclose a grinding method which is based on the grinder 1 and disc grinding device 2 in accordance with the invention and is correspondingly advantageous, and the use of such a grinder 1 and disc grinding device 2 in accordance with the invention for specific product types, products and results.

The material of the stator disc 3 and/or rotor disc 4 can be or contain Remanit from ThyssenKrupp or another austenitic steel, which brings particular advantages with respect to wear and corrosion resistance.

The grinder 1 can contain a pre-comminutor (not shown) with an integrated feed impeller (not shown) and a safety switch in particular for shut-off purposes. The grinder 1 can be designed for a specific maximum pressure in the product chamber, such as e.g. 0.7 bar. The grinder shaft can be held in a shaft seal e.g. made from tungsten carbide/carbon. As a drive for the disc grinding device 2 it is possible to use e.g. an AC motor with a thermistor probe (PTC) and a capacity of e.g. 5.5 kW and a rotational speed of 3000 rpm at a mains frequency of 50 Hz. The product outlet for the completely ground end product is advantageously preferably at the bottommost/lowest point of the housing of the grinder 1 in order to ensure optimal discharge. The disc grinding device 2 is preferably installed on or in the grinder 1 with the grinding shaft extending horizontally. In particular, an existing grinder can be refitted with a disc grinding device 2 in accordance with the invention.

The indications of dimensions and angles in FIGS. 3 and 9 are merely given by way of example and indicate preferred tolerances and preferred orders of magnitude in the range of +/−20%.

The invention is presented in the description and in the drawing with the aid of the exemplified embodiments merely by way of example and is not limited thereto but rather includes all variations, modifications, substitutions and combinations which a person skilled in the art can derive from the present documents in particular within the scope of the claims and of the general presentations in the introductory part of this description and of the description and drawing of the exemplified embodiments and can combine with his specialist knowledge in the art and the prior art. In particular, all individual features and design possibilities of the exemplified embodiments can be combined with each other.

### LIST OF REFERENCE SIGNS

1 grinder
2 disc grinding device
3 stator disc
4 rotor disc
5 stone plate
6 spring washer
7 feed vane
8 cam ring
9 cover
10 product in-feed/inlet

1. Disc grinding device (2) with a stator disc (3) and a rotor disc (4) which are disposed coaxially with respect to a common disc axis and have at least approximately the same diameter, and the mutually facing sides of which correspondingly contain an annular toothed stator surface and an annular toothed rotor surface, wherein the annular toothed stator surface contains at least one stator ring region with stator teeth, which are spaced apart by stator grooves in the peripheral direction, and the annular toothed rotor surface contains at least one rotor ring region with rotor teeth, which are spaced apart by rotor grooves in the peripheral direction, wherein the toothed rotor surfaces and the toothed stator surfaces define an annular grinding gap and are disposed and formed in such a way that the grinding gap becomes narrower radially in the direction from the disc axis towards the edge of the stator disc (3) and rotor disc (4), wherein in particular in addition at least one of the following design arrangements is provided
that the rotor teeth and rotor grooves extend in an inclined or curved manner with respect to the radial direction of the rotor disc (4) and in combination therewith the stator teeth and stator grooves extend pointing in the radial direction of the stator disc (3),
and/or
that at least two stator ring regions with stator teeth and/or rotor ring regions with rotor teeth lie adjacently in the radial direction of the stator disc (3) or rotor disc (4) respectively and have stator teeth or rotor teeth respectively and/or stator grooves or rotor grooves respectively of different designs, wherein
such adjacent stator ring regions and/or rotor ring regions are preferably separated by a mixing zone peripheral groove, and/or
preferably in such adjacent stator ring regions and/or rotor ring regions in a stator ring region or rotor ring region respectively lying radially further outwards in the direction from the disc axis towards the edge of the stator disc (3) and rotor disc (4), the stator grooves or rotor grooves respectively are narrower than in the stator ring region and/or rotor ring region lying adjacently further inwards radially thereto,
and/or
that the stator grooves and/or rotor grooves become narrower in the direction from the disc axis towards the edge of the stator disc (3) or rotor disc (4) respectively, i.e. in other words that the tooth arrangements become narrower radially from the disc axis towards the edge of the stator disc (3) and rotor disc (3).

2. Disc grinding device (2) as claimed in claim 1, wherein the rotor disc (4) rotates during operation at a speed of approximately 1000 to approximately 4000 rpm, preferably at least approximately 3000 rpm, in particular in an adjustable or controllable manner.

3. Disc grinding device (2) as claimed in claim 1, wherein the stator disc (3) is screwed to a grinder upper part and is advantageously displaceable axially along the disc axis, whereby preferably the size of a grinding gap in the axial direction between the stator disc (3) and rotor disc (4) is adjustable or controllable.

4. Disc grinding device (2) as claimed in claim 2, wherein the stator disc (3) is screwed to a grinder upper part and is advantageously displaceable axially along the disc axis, whereby preferably the size of a grinding gap in the axial direction between the stator disc (3) and rotor disc (4) is adjustable or controllable.

5. Disc grinding device (2) as claimed in claim 1, wherein a grinding gap between the stator disc (3) and rotor disc (4), in particular at the narrowest point, is approximately 0.3 to approximately 3 mm and in particular is adjustable or controllable.

6. Disc grinding device (2) as claimed in claim 1, wherein the toothed stator surface and the toothed rotor surface are disposed and/or formed in such a way that the grinding gap becomes wider in an edge region of the stator disc (3) and rotor disc (4).

7. Disc grinding device (2) as claimed in claim 5, wherein the grinding gap becomes wider in an edge region of the stator disc (3) and rotor disc (4).

8. Disc grinding device (2) as claimed in claim 1, wherein, over the whole grinding zone, the tooth arrangement is divided into different toothed circles, i.e. stator ring regions and/or rotor ring regions.

9. Disc grinding device (2) as claimed in claim 7, wherein a coarse tooth arrangement in the region adjoining the inner diameter, i.e. on the innermost stator ring region and/or rotor ring region, forms a pre-grinding zone.

10. Disc grinding device (2) as claimed in claim 7, wherein the tooth arrangement becomes finer from the inside to the outside with each toothed circle, i.e. each stator ring region and/or rotor ring region.

11. Disc grinding device (2) as claimed in claim 8, wherein the tooth arrangement becomes finer from the inside to the outside with each toothed circle, i.e. each stator ring region and/or rotor ring region.

12. Disc grinding device (2) as claimed in claim 1, wherein the groove depth of the stator grooves and/or rotor grooves between the teeth, i.e. corresponding to the stator teeth or rotor teeth respectively, extends in a conical manner.

13. Disc grinding device (2) as claimed in claim 10, wherein the stator grooves and/or rotor grooves become narrower towards the outer diameter of the stator disc and rotor disc.

14. Disc grinding device (2) as claimed in claim 1, wherein the groove width is at least approximately 1.5 to 3.5 times, in particular at least approximately 2.5 times, larger than the groove depth from the toothed stator surface and/or toothed rotor surface.

15. Disc grinding device (2) as claimed in claim 7, wherein each toothed circle, i.e. stator ring region and/or rotor ring region is subdivided with an annular groove which constitutes a mixing zone peripheral groove.

16. Grinder (1) having a disc grinding device (2) as claimed in claim 1.
